(19) United States
(12) Patent Application Publication
(10) Pub. No.: US 2010/0251330 A1
(43) Pub. Date: Sep. 30, 2010

(54) Optimized relaying of secure network entry of small base stations and access points

(76) Inventors: Dirk Kroeselberg, Munchen (DE); Domagoj Premec, Zagreb (HR)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/659,540

(22) Filed: Mar. 12, 2010

Related U.S. Application Data
(60) Provisional application No. 61/202,564, filed on Mar. 12, 2009.

(51) Int. Cl. H04L 29/06

(52) U.S. Cl. 726/3

(57) ABSTRACT

A method, apparatus, and computer program product, are provided to receive an authentication message initiated by a network access request to access a connectivity network. The authentication message may include a first communication protocol that is converted into at least one additional different protocol, and forwarded to an authentication function of a gateway of an access network prior to the authentication message being forwarded to the connectivity network.

### CROSS REFERENCE TO RELATED APPLICATIONS

The present application is related to, and claims the priority of, U.S. Provisional Patent Application No. 61/202,564, filed Mar. 12, 2009, the entirety of which is incorporated herein by reference.

### BACKGROUND

1. Field:

Embodiments of the present invention generally relate to communication systems and particularly to wireless telecommunications systems integrated with Internet engineering task force (IETF) and third generation partnership project (3GPP) authentication, authorization and accounting (AAA). Embodiments of the present invention also relate to world interoperability for microwave access (WiMAX) networks integrated with WiMAX Femto access points (WFAPs) or with WiFi access points.

2. Description of the Related Art

In a broadband access network, it is important that subscribers are ensured proper authentication access and a secure communication connection. Generally, a user needs to pass an AAA process of validity verification when accessing the network. According to a previously negotiated agreement, it may be determined whether or not the subscriber is authorized to access the network, as well as what services the subscriber may enjoy. A billing procedure may also be used to track the subscriber's usage of network resources.

In the AAA framework, an AAA protocol may be utilized as a carrier protocol of the authentication information. The AAA protocol is versatile and expandable, and may carry various authentication mechanisms (e.g., transport layer security (TLS), subscriber identity module (SIM), and authentication and key agreement (AKA)). The extensible authentication protocol (EAP) can also be used to carry such authentication protocols within a AAA protocol, but authentication protocols can also be carried directly within a AAA protocol.

WiMAX is a telecommunications technology that provides wireless transmission of data using a variety of transmission modes. For example, communication access may be provided by point-to-multipoint links, and may provide portable and mobile Internet access to subscriber/mobile stations. WiMAX provides a sample data rate of up to 72 Mbit/s of symmetric broadband speed without the need for cables. The technology is based on the IEEE 802.16 standard, which is also referred to as broadband wireless access. In general, WiMAX is a standards-based technology enabling the delivery of last mile wireless broadband access as an alternative to wired broadband solutions, such as, cable and DSL as well as fully mobile wireless broadband connectivity.

In a WiMAX network, user authentication and air interface security are important. The networking group (NWG) for the WiMAX forum has defined the use of EAP as a user authentication protocol that is used with an authentication process. In the WiMAX forum (WMF) networking group (NWG), a new solution is currently being developed as an initial step to create an even smaller network architecture referred to as Femto or a Femtocell. Previously, a microcell or picocell was introduced as a small area controlled by a relatively small base station that would provide localized subscriber station access to a network or the Internet. A Femtocell is an even smaller and more affordable solution to offering in home Internet access to subscriber stations.

As part of the WiMAX requirements discussion, service providers are requesting an architecture that allows both the WiMAX network access provider (NAP), or access services network (ASN) part, and the network service provider (NSP), or connectivity service network (CSN) part, to control parts of the connected WFAPs that are architecturally part of the ASN, although, typically being located in customer premises. For proper authentication (e.g., by EAP or AAA) between subscriber stations accessing a WFAP and its respective connection to the ASN or CSN, it is necessary to implement security solutions that match the requirements of each of the various network components and their respective communication protocols.

3GPP, for example, has defined a security solution for Femto (see 3GPP TR 33.820 “Security of H(e)NB”) that introduces a logical network entity “security gateway” (SG), which may be a standalone network element, or, alternatively may be part of an existing network element in the 3GPP network architecture, such as, for example, the HnB Gateway. The SG currently operates by terminating an Internet protocol security (Ipsec) tunnel with each of the connected WFAPs to protect all communication exchanged across the WFAP interface to the network.

Authentication of the WFAP and the SG can be performed, for example, based on the IETF RFC 4306 protocol, which is referred to as Internet key exchange version 2 (IKEv2), and which uses certificate-based security credentials (public/private key pairs signed by a certificate authority (CA)). However, this implementation requires a public/private key pair and certificate to be installed in the WFAP to allow the WFAP to authenticate itself with the network, and to permit the network to be in possession of a public/private key pair and certificate to authenticate itself against a WFAP. In addition to the above-noted network requirements, root CA certificates also need to be installed in the WFAP and the network to allow secure verification of the IKEv2 security credentials to be exchanged as part of the authentication process.

Furthermore, 3GPP TR 33.820, for example, describes an additional authentication procedure based on the EAP protocol, IETF RFC 3748, operating inside the IKEv2 protocol, which is used as a transport protocol for EAP. Currently, EAP is terminated in a AAA server operating in the network (i.e., a 3GPP AAA server). The protocol that is used to carry EAP messages between the SG and the AAA server may be Diameter, as described for example, in IETF RFC 3588, according to the standard IETF-defined AAA architecture.

It may be beneficial to map the above approach of using EAP/AAA and IKEv2 as a transport protocol in the WiMAX network architecture to leverage common network components and reduce development costs. However, as the WiMAX network architecture is fundamentally different from the 3GPP system architecture evolution (SAE), there is no simple solution to integrate these current networking architectures. 3GPP TR33.820 only considers a direct AAA connection from the SG to a AAA server and does not provide any support for a concrete WiMAX Femto security architecture that may be integrated with existing WFAP authentication and IKEv2 transport implementations.

### SUMMARY

In accordance with an embodiment of the invention, there is provided an apparatus. The apparatus includes a receiver configured to receive an authentication message initiated by a network access request to access a connectivity network. The authentication message includes a first protocol. The apparatus further includes a processor configured to convert the authentication message into a second protocol different from the first protocol. Further, the apparatus includes a transmitter configured to transmit the converted authentication message to an authentication function of a gateway of an access network prior to the authentication message being forwarded to the connectivity network.

In accordance with another embodiment of the invention, there is provided a method. The method includes receiving an authentication message initiated by a network access request to access a connectivity network. The authentication message includes a first protocol. The method further includes converting the authentication message into a second protocol different from the first protocol. Further, the method includes transmitting the converted authentication message to an authentication function of a gateway of an access network prior to the authentication message being forwarded to the connectivity network.

In accordance with another embodiment of the invention, there is provided another apparatus. The apparatus includes a receiver configured to receive an authentication message initiated by a network access request to access a connectivity network. The authentication message includes a first protocol. The apparatus further includes a processor configured to convert the authentication message into a second protocol different from the first protocol. The second protocol is configured to communicate with a gateway of an access network and configured to communicate with the connectivity network. Further, the apparatus includes a transmitter configured to transmit the converted authentication message to an authentication proxy of the gateway of the access network prior to the authentication message being forwarded to the connectivity network.

In accordance with another embodiment of the invention, there is provided another method. The method includes receiving an authentication message initiated by a network access request to access a connectivity network. The authentication message includes a first protocol. The method further includes converting the authentication message into a second protocol different from the first protocol. The second protocol is configured to communicate with a gateway of an access network and configured to communicate with the connectivity network. Further, the method includes transmitting the converted authentication message to an authentication proxy of the gateway of the access network prior to the authentication message being forwarded to the connectivity network.

In accordance with another embodiment of the invention, there is provided another apparatus. The apparatus includes receiving means for receiving an authentication message initiated by a network access request to access a connectivity network. The authentication message includes a first protocol. The apparatus further includes processing means for converting the authentication message into a second protocol different from the first protocol, and transmitting means for transmitting the converted authentication message to an authentication function of a gateway of an access network prior to the authentication message being forwarded to the connectivity network.

In accordance with another embodiment of the invention, there is provided another apparatus. The apparatus includes receiving means for receiving an authentication message initiated by a network access request to access a connectivity network. The authentication message includes a first protocol. The apparatus further includes processing means for converting the authentication message into a second protocol different from the first protocol. The second protocol is configured to communicate with a gateway of an access network and configured to communicate with the connectivity network. Further, the apparatus includes transmitting means for transmitting the converted authentication message to an authentication proxy of the gateway of the access network prior to the authentication message being forwarded to the connectivity network.

In accordance with another embodiment of the invention, there is provided a computer program product embodied on a computer readable storage medium. The computer program product is encoded with instructions to control a processor to perform a process. The process includes receiving an authentication message initiated by a network access request to access a connectivity network. The authentication message includes a first protocol. The process further includes converting the authentication message into a second protocol different from the first protocol. Further, the method includes transmitting the converted authentication message to an authentication function of a gateway of an access network prior to the authentication message being forwarded to the connectivity network.

In accordance with another embodiment of the invention, there is provided a computer program product embodied on a computer readable storage medium. The computer program product is encoded with instructions to control a processor to perform a process. The process includes receiving an authentication message initiated by a network access request to access a connectivity network. The authentication message includes a first protocol. The method further includes converting the authentication message into a second protocol different from the first protocol. The second protocol is configured to communicate with a gateway of an access network and configured to communicate with the connectivity network. Further, the method includes transmitting the converted authentication message to an authentication proxy of the gateway of the access network prior to the authentication message being forwarded to the connectivity network.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a communication system, in accordance with an embodiment of the present invention.

FIG. 2 illustrates another communication system, in accordance with an embodiment of the present invention.

FIG. 3 illustrates an apparatus, in accordance with an embodiment of the present invention.

FIG. 4 illustrates a flow diagram, in accordance with an embodiment of the present invention.

FIG. 5 illustrates another flow diagram, in accordance with an embodiment of the present invention.

### DETAILED DESCRIPTION

It will be readily understood that the components of the present invention, as generally described and illustrated in the figures herein, may be implemented in a wide variety of different configurations. Thus, the following detailed description of the embodiments of a method, an apparatus, a computer program product, and a system, as represented in the attached figures, is not intended to limit the scope of the invention, but is merely representative of selected embodiments of the invention.

Certain embodiments of the invention combine hardware and software components to create methods, apparatuses, computer program products, and a system for relaying Femto authentication across a WiMAX network when a Femto SG is a separate network element.

In addition, while the term “message” has been used in the description of embodiments of the present invention, the invention may be applied to many types of network data, such as packet, frame, datagram, etc. For purposes of the present invention, the term “message” also may include packet, frame, datagram, and any equivalents thereof. Furthermore, the term, “authentication” may be interchanged with the term, “authorization.” Furthermore, while certain types of messages are depicted in the following description, embodiments of the present invention are not limited to a certain type of message.

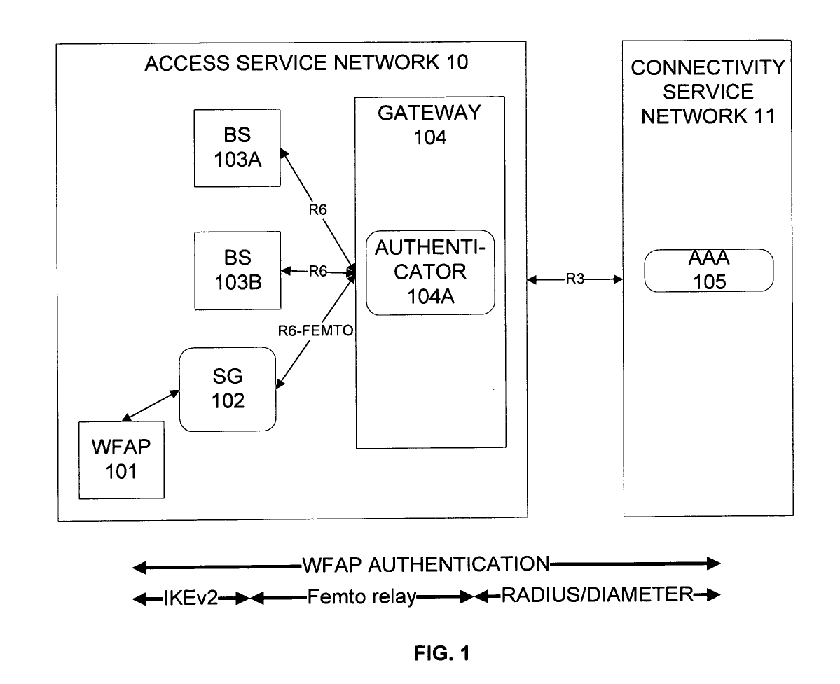

In an embodiment of the present invention, as illustrated in FIG. 1, an IPsec tunnel may be established between a WiMAX Femto access point (WFAP) 101 and a WiMAX security gateway (SG) 102. The WFAP 101 and the WiMAX SG 102 may be part of a WiMAX access service network (ASN) 10. The IPsec tunnel may be preserved and re-used for further security authentication. In other words, the IPsec tunnel may be maintained beyond the communications between the WFAP 101 and the SG 102, instead of terminating the IPsec tunnel at the SG 102. As illustrated in FIG. 1, an IKEv2 protocol may be used to provide authentication between the WFAP 101 and the SG 102. This authentication may require security credentials that match the WiMAX environment of a gateway 104 (GW).

Authentication of the WFAP 101 with a connectivity service network 11 (CSN) of a network service provider (NSP) may be based on an AAA protocol. The AAA protocol may additionally carry an EAP protocol for the purpose of authentication. However, an authentication and authorization client (AA client) part of the SG 102 may not support the SG 102 for exchanging EAP or AAA messages (e.g., carrying authentication messages) with the AAA server 105 of the CSN 11. The WiMAX ASN 10 does not include an AAA server 105 according to the current network specifications for WiMAX. When mapping the SG 102 to the GW 104, an authenticator 104A, or AAA client of the GW 104, may be used to exchange messages with the AAA server 105 in the CSN 11 based on a RADIUS protocol or a Diameter protocol. However, when the SG 102 is not co-located with the WiMAX GW 104 of the ASN 10, then providing authentication for the WFAP 101 may not be possible without an alternative network configuration to handle the authentication.

The GW 104 of the ASN 10 may be interchangeably referred to as a Femto-GW that provides gateway features for a WiMAX Fenito architecture. In detail, a deployment may realize the Femto-GW functionality of handling a potentially large number of Femtobase stations 103A and/or 103B, and/or, a WFAP 101. The Femto-GW may be a separate network entity, or, alternatively, may be part of the existing GW 104.

In order to enable the SG 102 to directly interface with the AAA server 105 in the CSN 11 across an R3 reference point (an R3 reference point defines control plane protocols, such as AAA, policy enforcement, and mobility management between ASNs and CSNs, for example, in accordance with the WiMAX specification WMF T33-001-R015v01), the SG 102 may be required to implement an AAA client functionality and an R3 interface functionality, for example, in accordance to the WiMAX specification WMF T33-001-R015v01, which may place significant additional requirements on the network implementation. In addition, the SG 102 may not utilize most of the functionality of the R3 interface, and may likely only need to implement a subset of the standardized communications to the AAA server 105 through the R3 interface. A SG 102 or Femto-specific variant of the R3 reference point to the AAA server 105 in the CSN 11 may be required to handle this subset of the common the AAA procedures. Such an implementation may place a burden on the AAA server 105 of the CSN 11, which would likely have to implement a reference point variation to communicate with the SG 102. Increasing the number of reference point variations may negatively impact interoperability between operators when performing roaming or interoperability between different equipment vendors.

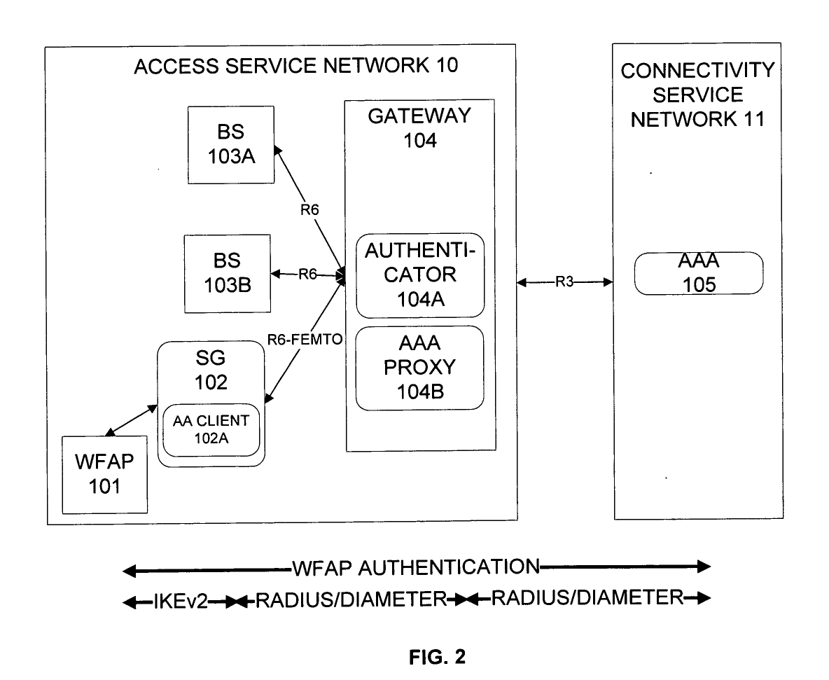

To establish direct connections between entities of the ASN 10 and the CSN 11 may require new routing paths to be installed along with corresponding security associations between those entities. Such an implementation may be considered costly for network deployments. One possibility may be to implement a Femto relay messaging protocol between the SG 102 and the GW 104, as illustrated in FIG. 1. Another possibility may be to implement a AAA proxy entity (e.g., AAA proxy 104B) in the ASN 10, as illustrated in FIG. 2 to bundle the AAA-related traffic security. Both of these examples of establishing AAA communications between the ASN 10 and the CSN 11 for a WiMAX networking system will be described in detail below.

FIG. 1 illustrates a communication system, in accordance with an embodiment of the present invention. In operation, a subscriber station (SS) or mobile station (MS) (not shown) may request access to a network (i.e., Internet) via the WFAP 101. The WFAP 101 may initiate a WFAP authentication procedure, for example, triggered by a SS or MS requesting network access, by sending an authentication trigger initiation message to the SG 102 to start an authentication message exchange between the authenticator 104A and the WFAP 101. The WFAP 101 may trigger the authenticator 104A by using an out-of-band indicator as the trigger initiation. As a result, the authenticator 104A may send the first authentication message that is related to the actual authentication itself to the WFAP 101.

As illustrated in FIG. 1, the SG 102 and the gateway, or GW/Femto-GW, 104, may both include a Femto authentication relay function that converts or binds the authentication messages between an IKEv2 protocol and a WiMAX R6 protocol. The authentication messages may originate as part of the end-to-end authentication procedure between the WFAP 101 and the AAA server 105 of the CSN 11. The entire authentication process may be based on an EAP-based WFAP authentication. However, IKEv2 may be used as a transport protocol to carry the authentication messages that may make use of EAP transport or on similar means. In addition, Femto authentication relay may be used to conform with the WiMAX R6 protocol, which is translated into a RADIUS or diameter protocol accessible by the AAA server 105.

The SG 102 may convert the authentication messages received from the WFAP 101 into Femto authentication relay messages and forward them to the GW/Femto-GW 104. Conversely, the SG 102 may also convert or bind the authentication messages received from the GW/Femto-GW 104 to IKEv2 messages for authentication through IKEv2 and forward them to the correct WFAP 101. The SG 102 may create a binding between an instance of the Femto authentication relay message across the R6-Femto connection and an instance of IKEv2 authentication with authentication messages included inside. Additionally, the GW/Femto-GW 104 security association with the CSN 11 and its corresponding AAA server 105 may be re-used.

The Femto authentication relay function may be based on messages defined in a network element outside the SG 102. As a result, existing WiMAX R6 messages, such as, Auth_Transfer are adopted to be used by the SG 102. The Auth_Transfer message may be extended by a new information element indicating that the current authentication process is related to a Femto subscription instead of a standard WiMAX MS subscription. This may allow the GW/Femto-GW 104 to distinguish between standard authentication exchanges and those specific to a Femto-based protocol.

Another configuration that may be implemented to handle the transfer of authentication messages, i.e., Femto authentication messages, between a WiMAX base station (BS 103A and/or 103B) and the GW/Femto-GW 104 may include a R6 Auth_Transfer message. In operation, the R6 Auth_Transfer message may be re-used from the original message transfer between the GW/Femto-GW 104 and the BS to also handle the message transfer between the SG 102 and the WFAP 101. By re-using the R6 Auth_Transfer message, it may be possible to circumvent the use of the IKEv2 protocol.

Alternatively, the GW/Femto-GW 104 may be informed about the type of authentication currently being used by the AAA server 105. For example, the AAA server 105 may include AAA signaling between the CSN 11 and ASN 10 across the R3 connection (e.g., as part of a RADIUS access-accept message or the corresponding Diameter message in the form of a new attribute value pair (AVP)). The AAA server 105 may inform the GW/Femto-GW 104 about the fact that this authentication is related to a WFAP subscription of a MS subscriber. The authentication message may be forwarded to the GW/Femto-GW 104 prior to the message being transferred to the CSN 11.

In order to bind the authentication messages to the IKEv2 transport protocol, or, to bind the authentication messages with Femto relay messages bound to the same WFAP 101, the SG 102 may utilize a WFAP identity that may be taken from a WFAP certificate that was used as part of the IKEv2 authentication between the WFAP 101 and SG 102. One example of the WFAP identity may include a network access identifier (NAI) that may include the operator realm information and the MAC address bound to the WFAP. An alternative example of the WFAP identity may include a value taken from the subject field or a “subjectAltName” field of an X.509 certificate. By using the WFAP identity of the WFAP certificate, this may provide an authenticated WFAP identity that may be used as an identifier in the authentication messages transferred between the SG 102 and the AAA server 105.

In another embodiment of the present invention, FIG. 2 illustrates an example of a communications network with an AA client function 102A being part of the SG 102. By including the AA client function 102A in the SG 102, it may be possible to provide AAA-proxy functionality directly to the SG 102 or the GW/Femto-GW 104. Additionally, the RADIUS and/or Diameter protocols may be extended to the SG 102. The GW/Femto-GW 104 may include a AAA-proxy functionality 104B in addition to the authenticator 104A that is in this alternative used for SS/MS authentication. The GW/Femto-GW 104 communicates with the SG 102 over the R6-Femto interface by using the RADIUS or Diameter protocol. As a result, the authentication messages handled by the SG 102 must be carried across the RADIUS or Diameter protocols. The authentication message may be forwarded to the GW/Femto-GW 104 prior to the message being transferred to the CSN 11.

By having its own AAA-proxy functionality 104B, the GW/Femto-GW 104 may handle the portion of the AAA protocol with the CSN 11 that is normally terminated at the GW/Femto-GW 104. In such a case, the GW/Femto-GW 104 may only be required to proxy the authentication messages carried by the AAA protocol between the SG 102 and the AAA server 105 of the CSN 11. As a result, the GW/Femto-GW 104 may be configured to act as a mediation device that may additionally convert between RADIUS and Diameter in case the SG 102 and the AAA server 105 use different AAA protocols. For example, the GW/Femto-GW 104 may evaluate and partially remove message parts (i.e., attributes for RADIUS or AVPs for Diameter), or, add message parts based on the direction the authentication message is being sent. The GW/Femto-GW 104 security association with the CSN 11 and the AAA server 105 may be re-used.

In order to bind the authentication messages to the IKEv2 transport protocol, or, to bind the authentication messages with Femto relay messages bound to the same WFAP 101, the SG 102 may utilize a WFAP identity that may be taken from a WFAP certificate that was used as part of the IKEv2 authentication between the WFAP 101 and SG 102. One example of the WFAP identity may include a NM that may include the operator realm information and the MAC address bound to the WFAP. An alternative example of the WFAP identity may include a value taken from the subject field or a “subjectAltName” field of an X.509 certificate. By using the WFAP identity of the WFAP certificate, this may provide an authenticated WFAP identity that may be used as an identifier in the authentication messages transferred between the SG 102 and the AAA server 105.

In accordance with an embodiment of the present invention, it is considered beneficial that the AAA server 105 may include an information element to the GW/Femto-GW 104 in the AAA signaling between the CSN 11 and ASN 10 across the R3 connection. For example, the information element may be part of a RADIUS access accept message or a corresponding Diameter message in the form of a new attribute AVP. It would also be beneficial if the AAA server 105 were to inform the GW/Femto-GW 104 about the fact that this authentication is related to a WFAP subscription of a MS subscriber.

All of the above embodiments provide that the SG 102 may be implemented as a separate entity from the GW/Femto-GW 104, or, any other Femto gateway in the WiMAX communications environment. Such an implementation may be beneficial in the deployment of current and/or future WiMAX network implementations as it becomes possible to offload the security processing to a separate entity that will not impact the operations of existing WiMAX network entities.

In addition, the above embodiments may permit the re-use of existing protocol functionality within the ASN 10 (i.e., the R6 reference points) as much as possible. These embodiments may also fully support the WiMAX ASN 10 internal mobility related to the use of the R4 reference point, including keeping an anchor authenticator in a separate place from the actual ASN GW 104 that is in communication with the WFAP 101, enabling WFAP mobility within the domain of the ASN 10. Furthermore, a WiMAX network may be implemented without requiring Femto-specific versions of the WiMAX communication between the ASN 10 and the CSN 11 (i.e., R3 and R5 reference points interfacing different entities and operators) that would complicate and adversely impact interoperability of such communication.

For each of the embodiments of the present invention disclosed above, methods may also be applied to other types of base stations and access points (i.e., non-Femto base stations) that need specific security measures in place. For example, certain base stations may be located in an exposed environment and may be physically accessible to security attacks. This may include other radio technologies including WLAN (802.11) access points.

Each of the network elements illustrated in FIGS. 1 and 2 may include a computing device and a computer readable storage medium. In addition, each of the network elements may further include a receiver and a transmitter to receive and transmit information, respectively. Furthermore, each of the network elements may also include a processor to perform computations and to process information received according to the embodiments described throughout the specification.

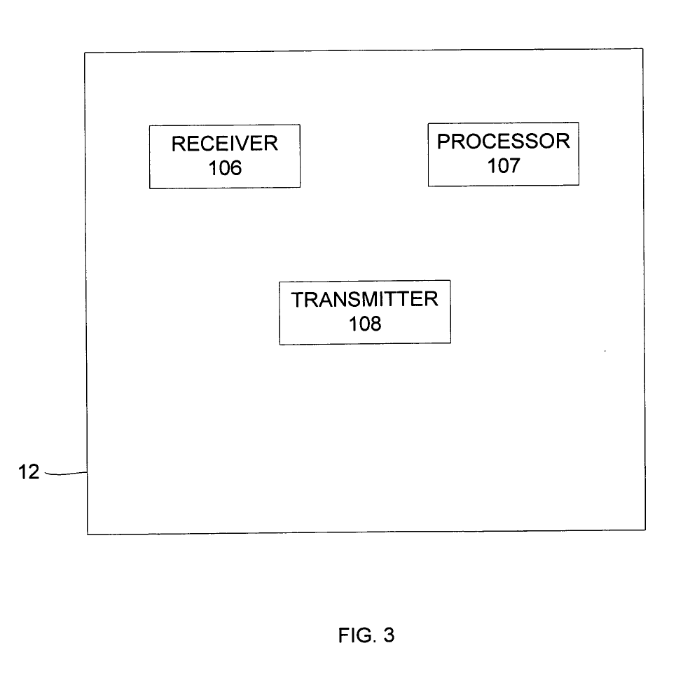

For example, as illustrated in FIG. 3, an embodiment of the invention provides an apparatus 12. The apparatus may include a receiver 106, a processor 107, and a transmitter 108. The receiver 106 may be configured to receive an authentication message initiated by a network access request to access a connectivity network. The authentication message may include a first protocol. The network access request may include a request from a MS or BS to connect to the Internet. The receiver may further be configured to receive the authentication message from an access point, for example, a WiMAX Femto access point or a WiFi access point in response to a request to connect to the Internet from a mobile node, for example, the MS or BS.

The processor 107 may be configured to convert the authentication message into a second protocol different from the first protocol. The first protocol may include an IKEv2 protocol and the second protocol may include a Femto relay protocol.

The transmitter 108 may be configured to transmit the converted authentication message to an authentication function (e.g., authenticator function 104A) of a gateway (e.g., GW/Femto-GW 104) of an access network (e.g., access service network 10) prior to the authentication message being forwarded to the connectivity network (e.g., connectivity service network 11).

The authentication function of the gateway may be configured to exchange messages with an AAA server (e.g., AAA server 105) located in the connectivity network. The authentication function may include an AAA proxy server (e.g., AAA 104B) configured to proxy an authentication portion of an AAA protocol to communicate with the connectivity network.

The gateway may be configured to convert the converted authentication message to a third protocol that is different from the first and the second protocols. The third protocol may include a RADIUS or a Diameter.

One of the access network and the connectivity network may be configured to operate using a Femto protocol or a WiMAX protocol.

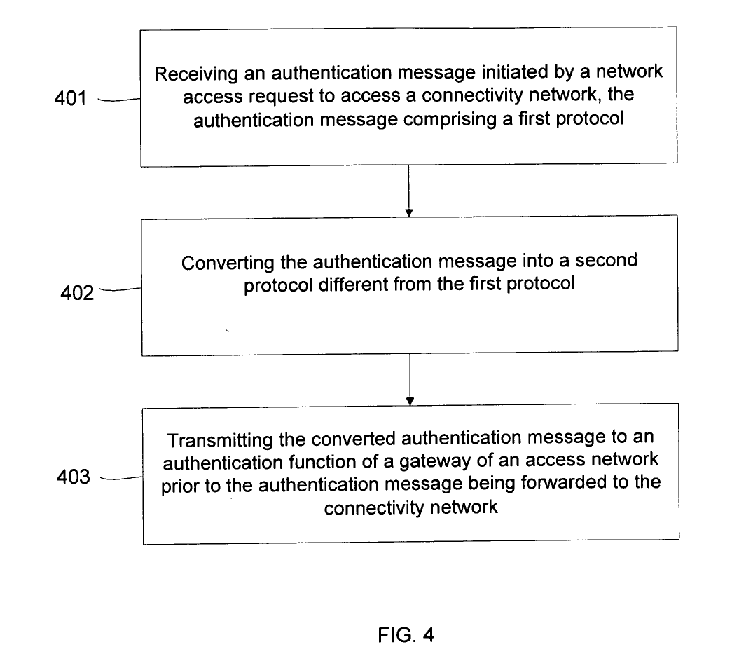

FIG. 4 illustrates a flow chart for a method, in accordance with an embodiment of the present invention. In step 401, the method may include receiving an authentication message initiated by a network access request to access a connectivity network. The authentication message may include a first protocol (e.g., a communication protocol). In step 402, the method may include converting the authentication message into a second protocol different from the first protocol. In step 403, the method may include transmitting the converted authentication message to an authentication function of a gateway of an access network prior to the authentication message being forwarded to the connectivity network.

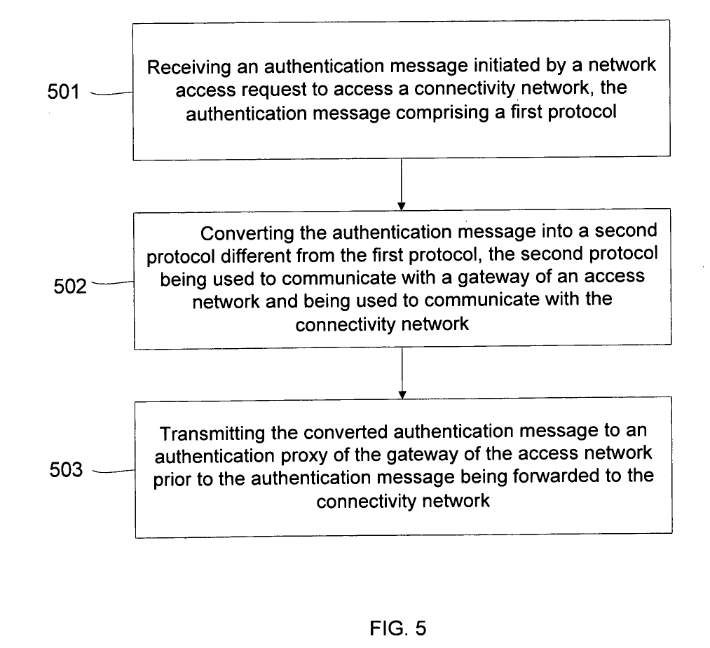

FIG. 5 illustrates a flow chart for a method, in accordance with an embodiment of the present invention. The method may include receiving an authentication message initiated by a network access request to access a connectivity network (step 501). The authentication message may include a first protocol (e.g., a communication protocol). The method may further include converting the authentication message into a second protocol different from the first protocol (step 502). The second protocol may be used to communicate with a gateway of an access network and being used to communicate with the connectivity network. Further, the method may include transmitting the converted authentication message to an authentication proxy of the gateway of the access network prior to the authentication message being forwarded to the connectivity network (step 503).

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art. An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

One having ordinary skill in the art will readily understand that the invention as discussed above may be practiced with steps in a different order, and/or with hardware elements in configurations which are different than those which are disclosed. Therefore, although the invention has been described based upon these preferred embodiments and non-limiting embodiments, it would be apparent to those of skill in the relevant art that certain modifications, variations, and alternative constructions would be apparent, while remaining within the spirit and scope of the invention. Thus, the example embodiments do not limit the invention to the particular listed devices and technologies. In order to determine the metes and bounds of the invention, therefore, reference should be made to the appended claims.

We claim:

1. An apparatus, comprising:
a receiver configured to receive an authentication message initiated by a network access request to access a connectivity network, wherein the authentication message comprises a first protocol;
a processor configured to convert the authentication message into a second protocol different from the first protocol; and
a transmitter configured to transmit the converted authentication message to an authentication function of a gateway of an access network prior to the authentication message being forwarded to the connectivity network.

2. The apparatus of claim 1, wherein the transmitter is further configured to transmit the converted authentication message to the authentication function configured to exchange messages with an authentication, authorization and accounting server located in the connectivity network.

3. The apparatus of claim 1, wherein the transmitter is further configured to transmit the converted authentication message to the authentication function of the gateway comprising an authentication, authorization and accounting proxy server configured to proxy an authentication portion of an authentication, authorization and accounting protocol to communicate with the connectivity network.

4. The apparatus of claim 1, wherein the transmitter is further configured to transmit the converted authentication message to the authentication function of the gateway configured to convert the converted authentication message to a third protocol that is different from the first and the second protocols.

5. The apparatus of claim 1, wherein the transmitter is further configured to transmit the converted authentication message to the authentication function of the gateway configured to convert the converted authentication message to one of a remote authentication dial-in user service and a diameter protocol.

6. The apparatus of claim 1, wherein the processor is further configured to convert the authentication message into the second protocol different from the first protocol, the first protocol comprising an Internet key exchange version 2 and the second protocol comprising a Femto relay.

7. The apparatus of claim 1, wherein the receiver is further configured to receive the authentication message initiated by the network access request comprising the request to connect to an access network, an IP-based network service, or the Internet.

8. The apparatus of claim 1, wherein the receiver is further configured to receive the authentication message from a world interoperability for microwave access femto access point or a wireless fidelity access point in response to a request to connect to an access network, an IP-based network service, or the Internet from a mobile node.

9. The apparatus of claim 1, wherein the receiver is further configured to receive the authentication message to access the connectivity network configured to operate using a Femto protocol, and wherein the transmitter is further configured to transmit the converted authentication message to the authentication function of the gateway of the access network configured to operate using the Femto protocol.

10. The apparatus of claim 1, wherein the receiver is further configured to receive the authentication message to access the connectivity network configured to operate using a world interoperability for microwave access protocol, and wherein the transmitter is further configured to transmit the converted authentication message to the authentication function of the gateway of the access network configured to operate using the world interoperability for microwave access protocol.

11. The apparatus of claim 1, wherein the receiver is further configured to receive the authentication message comprising an identifier, and wherein the transmitter is further configured to transmit the converted authentication message comprising the identifier to the authentication function of the gateway of the access network prior to the authentication message being forwarded to the connectivity network.

12. A method, comprising:
receiving an authentication message initiated by a network access request to access a connectivity network, wherein the authentication message comprises a first protocol;
converting the authentication message into a second protocol different from the first protocol; and
transmitting the converted authentication message to an authentication function of a gateway of an access network prior to the authentication message being forwarded to the connectivity network.

13. The method of claim 12, wherein the transmitting comprises forwarding the converted authentication message to the authentication function for exchanging messages with an authentication, authorization and accounting server located in the connectivity network.

14. The method of claim 12, wherein the transmitting comprises forwarding the converted authentication message to the authentication function comprising an authentication, authorization and accounting proxy server configured to proxy an authentication portion of an authentication, authorization and accounting protocol to communicate with the connectivity network.

15. The method of claim 12, wherein the transmitting comprises forwarding the converted authentication message to the authentication function of the gateway to convert the authentication message to a third protocol that is different from the first and the second protocol.

16. The method of claim 12, wherein the converting comprises converting the authentication message to at least one of a remote authentication dial-in user service and a diameter protocol.

17. The method of claim 12, wherein the converting comprises converting the authentication message comprising an Internet key exchange version 2 into the second protocol comprising a femto authentication relay.

18. The method of claim 12, wherein the receiving comprises receiving the authentication message initiated by the network access request comprising a request to connect to an access network, an IP-based network service, or to the Internet.

19. The method of claim 12, wherein the receiving comprises receiving the authentication message from a world interoperability for microwave access femto access point or a wireless fidelity access point in response to a request to connect to an access network, an IP-based network service, or the Internet from a mobile node.

20. The method of claim 12, wherein the receiving comprises receiving the authentication message comprising an identifier, and wherein the transmitting comprises forwarding the converted authentication message comprising the identifier to the authentication function of the gateway of the access network prior to the authentication message being forwarded to the connectivity network.

21. An apparatus, comprising:
a receiver configured to receive an authentication message initiated by a network access request to access a connectivity network, wherein the authentication message comprises a first protocol;
a processor configured to convert the authentication message into a second protocol different from the first protocol, wherein the second protocol is configured to communicate with a gateway of an access network and configured to communicate with the connectivity network; and
a transmitter configured to transmit the converted authentication message to an authentication proxy of the gateway of the access network prior to the authentication message being forwarded to the connectivity network.

22. A method, comprising:
receiving an authentication message initiated by a network access request to access a connectivity network, wherein the authentication message comprises a first protocol;
converting the authentication message into a second protocol different from the first protocol, wherein the second protocol is configured to communicate with a gateway of an access network and configured to communicate with the connectivity network; and
transmitting the converted authentication message to an authentication proxy of the gateway of the access network prior to the authentication message being forwarded to the connectivity network.

23. An apparatus, comprising:
receiving means for receiving an authentication message initiated by a network access request to access a connectivity network, wherein the authentication message comprises a first protocol;
processing means for converting the authentication message into a second protocol different from the first protocol; and
transmitting means for transmitting the converted authentication message to an authentication function of a gateway of an access network prior to the authentication message being forwarded to the connectivity network.

24. An apparatus, comprising:
receiving means for receiving an authentication message initiated by a network access request to access a connectivity network, wherein the authentication message comprises a first protocol;
processing means for converting the authentication message into a second protocol different from the first protocol, wherein the second protocol is configured to communicate with a gateway of an access network and configured to communicate with the connectivity network; and
transmitting means for transmitting the converted authentication message to an authentication proxy of the gateway of the access network prior to the authentication message being forwarded to the connectivity network.

25. A computer program product embodied on a computer readable storage medium, the computer program product being encoded with instructions to control a processor to perform a process, the process comprising:
receiving an authentication message initiated by a network access request to access a connectivity network, wherein the authentication message comprises a first protocol;
converting the authentication message into a second protocol different from the first protocol; and
transmitting the converted authentication message to an authentication function of a gateway of an access network prior to the authentication message being forwarded to the connectivity network.

26. A computer program product embodied on a computer readable storage medium, the computer program product being encoded with instructions to control a processor to perform a process, the process comprising:
receiving an authentication message initiated by a network access request to access a connectivity network, wherein the authentication message comprises a first protocol;
converting the authentication message into a second protocol different from the first protocol, wherein the second protocol is configured to communicate with a gateway of an access network and configured to communicate with the connectivity network; and
transmitting the converted authentication message to an authentication proxy of the gateway of the access network prior to the authentication message being forwarded to the connectivity network.
